(19) United States
(12) Patent Application Publication
(10) Pub. No.: US 2007/0103670 A1
(43) Pub. Date: May 10, 2007

(54) Fault detection in optical fibers

(75) Inventors: Omur M. Sezerman, Kanata (CA); Gordon Youle, Stittsville (CA)

Correspondence Address: JONES, TULLAR & COOPER, P.C., P.O. BOX 2266 EADS STATION, ARLINGTON, VA, 22202, US

(73) Assignee: Oz Optics Ltd.

(21) Appl. No.: 11/594,103

(22) Filed: Nov. 8, 2006

Related U.S. Application Data
(60) Provisional application No. 60/734,323, filed on Nov. 8, 2005.

(51) Int. Cl. G01N 21/00

(52) U.S. Cl. 356/73.1

(57) ABSTRACT

A system and method for remotely detecting and reporting faults in optical fibers is provided. Using a device similar to an Optical Time Domain Reflectometer (OTDR), breaks or sharp bends in an optical fiber can be detected, and the location of such events precisely determined, based on the time required for an optical pulse to travel from the device to the bend or break, and back to the device again. The location of reflections caused by breaks or poor connections may be identified, as well as the locations of attenuating events due to bends or other losses in the fiber. Unlike a conventional OTDR, the location of the event can be transmitted to a technician or central office via a radio link, allowing real-time reporting of the operational status of a fiber. Large numbers of fibers may be continuously monitored in real-time by permanently installing such monitoring systems in a network. The location of events may be determined in active communication fibers, or in passive fiber sensors used for monitoring of large-scale structures.

### CROSS-REFERENCE TO RELATED APPLICATION

This application claims the benefit of U.S. Provisional Patent Application No. 60/734,323 filed Nov. 8, 2005.

### FIELD OF THE INVENTION

The present invention relates in general to the detection of faults in optical fibers, primarily in optical fiber transmission lines or fiber sensors, and in particular to the wireless transmission of detected fault information.

### BACKGROUND OF THE INVENTION

The ability of a receiver in a data link to successfully decode a signal is partially dependent on the distortion introduced by the transmission medium, whether it is wire, optical fiber, free space, or something else. This distortion can include various levels of attenuation of the signal, non-linear distortion, echoes, or other effects. In order to minimize the distortion in a signal passing through a physical medium, it is important that the transmission medium be properly maintained to meet its expected specifications.

An earlier U.S. provisional patent application, No. 60/710,189 of Omur M. Sezerman and Gordon Youle, entitled “REMOTE MONITORING OF OPTICAL FIBERS” describes a means for monitoring the optical power in a fiber, and wirelessly communicating that information to an operator or central station. With that invention, one could determine if there was a problem in the optical network if it caused an attenuation of the signal reaching the measurement device. It could not, however, determine if there were problems located downstream of the sensing device. It could only determine if the signal was attenuated before reaching the sensing device. There is clearly a need for a simple and inexpensive means for monitoring an entire optical fiber line to determine if a fault exists therein and to also determine the location of that fault within the transmission line.

### SUMMARY OF THE INVENTION

The present invention deals with a means of monitoring a transmission medium, in this case an optical fiber, with the goal of simplifying the task of finding real or potential problems with the fiber optic link. This is done by means of a device that becomes an integral part of the transmission medium, which is able to measure specific parameters associated with that medium, and report the findings of such testing to an operator or automated monitoring system not in direct physical contact with the measurement device. The separation of the measurement device and the operator or monitoring system may range form less than a meter to many kilometers.

The new invention described in this application allows detection and reporting of problems that may occur beyond the sensing device. The information collected by the device can be wirelessly communicated to an operator, or central station.

The data collection is achieved with a low-cost Optical Time Domain Reflectometer (OTDR). An OTDR is a device that launches an optical pulse into a fiber. Any imperfections in the signal path will cause some of the light to be reflected back towards the OTDR. The OTDR measures and records any returned signals as a function of time, which is closely correlated to the distance along the fiber to the point or points of reflection. A point or region of optical attenuation can also be detected by this means, as it causes a change in the amount of light that is scattered or reflected back to the OTDR due to Rayleigh scattering. Rayleigh scattering is a phenomenon that is characteristic of optical fibers that causes a tiny portion of incident light to scatter due to fiber imperfections on a scale much smaller than the wavelength of the light. A detailed description of an OTDR can be found in prior art, such as U.S. Pat. No. 6,674,518

A similar device, sometimes called a fault finder, operates on the same principles as an OTDR, providing the distance to an optical event (which can be either reflective or attenuating) but it does not provide as much detailed information about the amplitude of the signal as a function of time (or distance). Since the fault finder provides less information than an OTDR, it generally costs less than an OTDR. The present invention applies to both a wireless OTDR as well as to a wireless fault finder. Although neither the OTDR nor the fault finder themselves are new devices, it is believed that the application of wirelessly transmitting this information to a user or central station for the purpose of long-term, continuous monitoring has not previously been attempted.

By using a wavelength that is different from the wavelength used for carrying data on the fiber of interest, it is possible with the present invention to perform continuous monitoring of the optical network at the same time that data is passing through the fiber. Hence, it is not necessary to interrupt the flow of data to carry out testing of the network.

With a conventional OTDR, a user will connect the device to an optical network requiring debugging or repair. With the present invention, the device may be an integral part of the optical installation, allowing permanent or long-term monitoring of the optical path.

The part of the design that is unique is the manner in which the information is conveyed to the user. In a convention OTDR, a user must look at a display to view a trace of the collected signal. Alternatively, the OTDR can be connected to a computer for logging or analysing the information. With the present invention a bi-directional wireless link, for transferring the information to a remote user or central station, is incorporate in the optical network. The advantage of this technique is that it does not require the presence of an operator at the location of the device, nor does it require a physical connection to the instrument.

In the event that a technician is in the general vicinity of the wireless OTDR, he can communicate with the OTDR using a laptop computer, smart cell phone, or other suitable communications device, as long as it has a compatible wireless transceiver. With a smart cell phone, information received from the OTDR can be displayed to the operator either graphically or as text. Alternatively, information can be forwarded to another location using the telecommunication capabilities of the phone.

Although wireless OTDR technology is described in U.S. Pat. No. 5,754,285, that application is specific to testing the quality of splices made in an optical cable. Furthermore, it does not apply to the monitoring of active fibers that are carrying data while the measurements are being made. The present invention is broader in scope in that it is intended to monitor a wider variety of causes of signal degradation, including breaks and bends, as well as other effects that may lead to optical reflections or attenuations. The present invention also applies to fiber sensor monitoring of large-scale structures.

### BRIEF DESCRIPTION OF THE DRAWINGS

FIG. 1 illustrates, schematically, a typical configuration for the present invention.

FIG. 2 illustrates, schematically, a more detailed configuration for the present invention.

FIG. 3 illustrates, schematically, a typical sensing application for the present invention.

### DESCRIPTION OF THE INVENTION

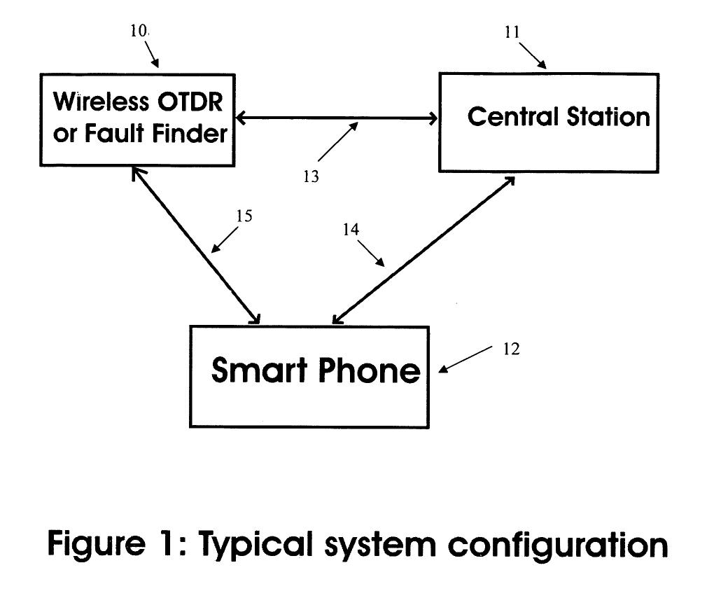

A typical configuration is illustrated in FIG. 1, showing that communication links can be established between the OTDR and a central station or nearby technician with a suitably configured smart phone. The communication link between the technician and the central station via the smart phone is also shown. In this figure, fault finder 10 of the invention, a central office 11, a smart cellular phone 12, the communications link 13 between the fault finder and the central office, a communications path 14 between the central office and the smart cellular phone, and a communication path 15 between the smart cellular phone and the fault finder are illustrated.

Since the invention is intended for permanent or long-term monitoring, it is expected that it will make a large number of measurements during its lifetime. Unlike a conventional OTDR which requires that an operator manually connect it to a network optically and/or electrically, the present invention requires neither, after the initial installation. This means that the time associated with making an optical link or electrical connection is eliminated. This saving of time can be significant, as it would otherwise involve opening a fiber pathway, cleaning optical connectors, establishing the opto-mechanical link to the OTDR, and reversing the process after the debugging has been completed. Similarly, there would be time associated with making an electrical connection. The establishing of optical or electrical connections may be difficult if the only available points of connection are in hard-to-reach places. With the present invention, no such connections are required. In addition to saving time, utilization of the present invention also eliminates repeatability issues that would be caused if the optical link had to be opened to connect a conventional OTDR.

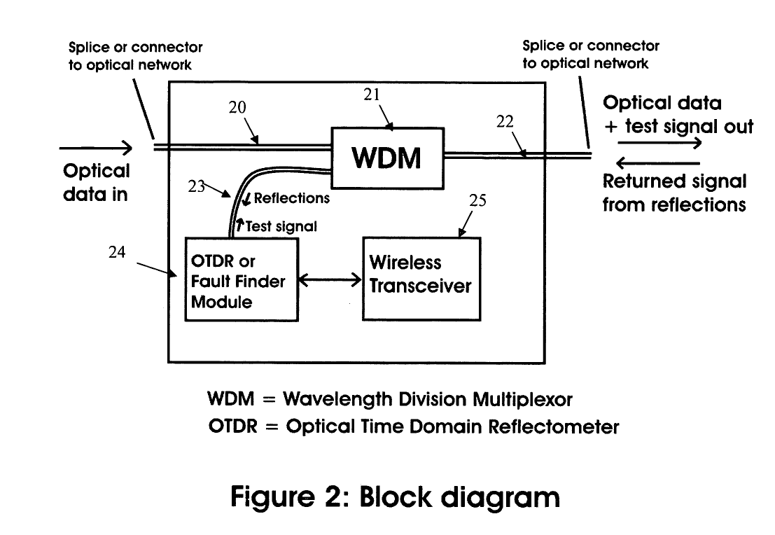

As shown in FIG. 2, the invention consists of three parts: a “conventional” OTDR or fault finder 24, a wavelength division multiplexor (WDM) 21, and the wireless communication module 25. The WDM 21 allows a test signal to be combined with data traffic of a different wavelength on the fiber. The data traffic may be unidirectional or bidirectional. Any reflected signal is similarly separated from the data traffic, and passed back to the OTDR. The wireless module in FIG. 2 is the part that handles communication between the OTDR and remote operator or central station. FIG. 2 also illustrates the input fiber 20 carrying data, the output fiber 22 carrying both data and the OTDR signal, and the OTDR fiber 23 carrying both the outgoing pulse and the returned signal.

The OTDR or fault finder may be either spliced into an optical network, or connected by means of optical connectors. The preferred embodiment would generally use an optical splice, as this would minimize the overall losses and reflections that would otherwise be caused by a connector.

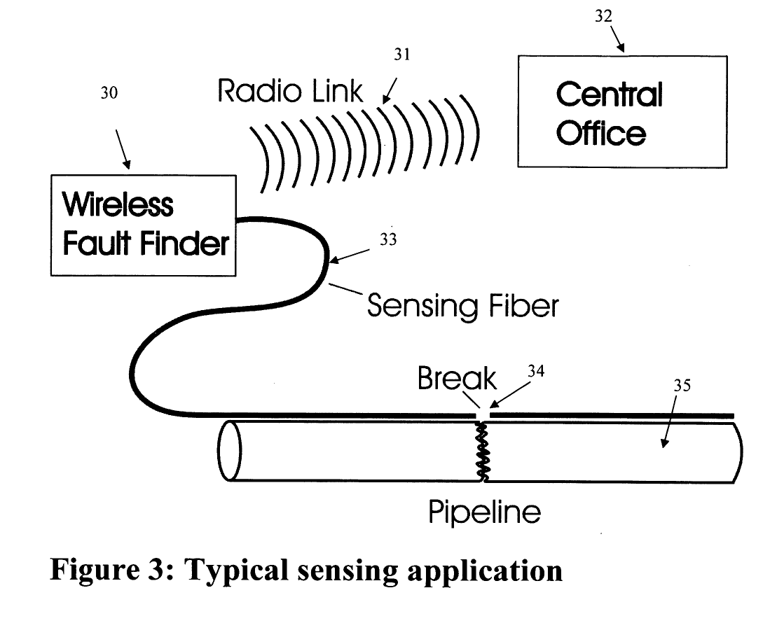

In an alternate embodiment of the invention, the OTDR or fault finder may be used in sensor applications, where it can perform remote monitoring of large structures such as buildings, bridges, dams, or pipelines. Failures of the structures will break the fiber, resulting in a large optical reflection at the point of failure, that the OTDR or fault finder can sense and pinpoint. Wireless communication with a central office or technician can lead to a minimum response time in dealing with the failure. This rapid response may save lives, money, and down time, or minimize the impact of a potential environmental disaster. FIG. 3 illustrates a typical sensing application, showing the OTDR or fault finder 30, a radio communications link 31 communicating with a central office 32, the sensing fiber 33, a break 34 in that sensing fiber, and a pipeline 35 representative of a structure with which the invention may be utilized.

In the case of a sensing application, the sensing fiber may optionally be used with a wavelength division multiplexer for simultaneously carrying communication signals of a wavelength different from that used by the OTDR or Fault Finder. If communication signals are not carried by the fiber, the wavelength division multiplexer is not required.

In summary, the present invention allows for continuous or programmed testing of the fibers of optical networks or monitoring sensors, for the immediate detection of any faults, for the immediate identification of the location of the fault, and for the wireless transmission of detected fault information to a monitoring station or a service person. Savings in service costs and reductions in network downtime can be realized with the present invention.

1. A method of servicing an optical network including at least one optical transmission fiber along which data is to be transmitted at a first optical wavelength comprising the steps of: connecting a continuously operable fault finder to said fiber; transmitting an optical signal from said fault finder at a second optical wavelength along said fiber; analyzing any returned optical signal initiated by a fault in said fiber to determine the existence of such fault and the location thereof along said fiber; and wirelessly transmitting information characteristic of the detected fault by a transmitter connected to said fault finder so that action pertaining to the fault can be taken as a result of reception of such information.

2. The method of claim 1 wherein said fault finder is an Optical Time Domain Reflectometer (OTDR).

3. The method of claim 1 wherein said fault finder includes a transceiver for receiving interrogation signals and transmitting data in response to such interrogation signals.

4. The method of claim 1 wherein information transmitted from said fault finder is receivable by a laptop computer, a smart cellular telephone or by other suitable communications devices.

5. A method of fiber sensor monitoring by an optical fault finder, comprising the steps of transmitting an optical signal from said fault finder along said fiber; analyzing any returned optical signal initiated by a fault in said fiber to determine the existence of such fault and the location thereof along said fiber; and wirelessly transmitting information characteristic of the detected fault by a transmitter connected to said fault finder so that action pertaining to the fault can be taken as a result of reception of such information.

6. The method of claim 5 wherein information transmitted from said fault finder is receivable by a laptop computer, a smart cellular telephone or by other suitable communications devices.
